(19) United States
(12) Patent Application Publication
(10) Pub. No.: US 2018/0221932 A1
(43) Pub. Date: Aug. 9, 2018

(54) A METHOD OF MANUFACTURING AN ARC CORNER CONNECTING A RIB OF A METAL BOX SHELL

(71) Applicant: Xiaoming FEI, Wujiang District (CN)

(72) Inventor: Xiaoming FEI, Wujiang District (CN)

(21) Appl. No.: 15/579,933

(22) PCT Filed: Nov. 12, 2015
(86) PCT No.: PCT/CN2015/094435

§ 371 Date: Dec. 5, 2017

(30) Foreign Application Priority Data
Jul. 29, 2015 (CN) 201510455137.0

(51) Int. Cl. B21D 22/26; B21D 17/02; B21D 53/36; B21D 22/20; B21D 22/30

(52) U.S. Cl. CPC B21D 22/26; B21D 17/02; B32B 15/012; B21D 22/206; B21D 22/30; B21D 53/36

(57) ABSTRACT

A method of manufacturing an arc corner connecting rib of a metal box shell is disclosed. The method of manufacturing comprises the following steps: preparing a rectangular metal shell whose vertex corner portions are arc corner transition portions; drawing for a first time by means of a first metal drawing mold a top face plate of the rectangular metal shell, so that a plurality of first convex strips are formed in a first area between the two arc corner transition portions of the top face plate; and drawing for a second time by means of a second metal drawing mold a side face plate and the arc corner transition portions of the rectangular metal shell obtained after the first drawing molding, so that a plurality of second convex strips are formed in a second area between the two arc corner transition portions of the side face plate.

### CROSS-REFERENCE TO RELATED APPLICATION

This application claims priority to Chinese Patent Application No. 201510455137.0 filed Jul. 29, 2015, and is a national stage application of International Application No. PCT/CN20151094435, filed internationally on Nov. 12, 2015, each of which is incorporated by reference herein in its entirety.

### TECHNICAL FIELD

The present disclosure relates to the manufacturing field of metal boxes, and more particularly, to a method of manufacturing an arc corner connecting rib of a metal box shell.

### BACKGROUND

Rigid shaped boxes and bags are widely used as they can keep their appearance and protect the articles therein to some extent. In particular, aluminum alloy boxes are the most popular as they can protect internal components. Furthermore, owing to the characteristics of being reasonable in design, firm in structure, attractive in appearance, easy to use, and the like, the aluminum alloy boxes are widely used in industries of instruments, meters, electronics, communications, automation, sensors, precision machinery, and so on, and are ideal boxes for high-grade instruments and meters. In general, existing boxes and box covers adopt integrally drawn structures in which corrugated grooves or convex strips are manufactured on the upper and lower surfaces of the boxes. However, there is no box whose side surfaces are provided with corrugated grooves or convex strips. If such a box is manufactured through one-step drawing molding, a mold therefor is relatively complex, and demolding in the molding process is very difficult. In particular, it is very hard to draw a convex strip between arc corner transition portions of the box, and defective products may be produced as the possibility of mold clamping in the drawing process is high.

### SUMMARY

In order to solve one or more of the above problems, the present disclosure provides a method of manufacturing an arc corner connecting rib of a metal box shell.

According to an aspect of the present disclosure, a method of manufacturing an arc corner connecting rib of a metal box shell is disclosed. The method of manufacturing comprises preparing a rectangular metal shell whose vertex corner portions are arc corner transition portions. Drawing for a first time by means of a first metal drawing mold a top face plate of the rectangular metal shell, so that a plurality of first convex strips are formed in a first area between the two arc corner transition portions of the top face plate. Drawing by means of a second metal drawing mold a side face plate and the arc corner transition portions of the rectangular metal shell obtained after the first-time drawing molding second time, so that a plurality of second convex strips are formed in a second area between the two arc corner transition portions of the side face plate. The method of manufacturing has the beneficial effects that through the first drawing, the plurality of first convex strips are formed in the first area; and through the second drawing, the plurality of second convex strips are formed in the second area between the arc corner transition portions. As there is a groove between the two second convex strips, it may be hard to demold through only the first drawing molding, and also the second drawing molding is performed. Therefore, through two times of drawing, the arc corners can be orderly, and a stress capacity of the arc corners is improved. Convex grain can be formed on the shell, especially at the arc corners, so that the shell is attractive and durable. Demolding is facilitated in the whole manufacturing process, the production process is simplified, and the occurrence rate of defective products is reduced.

In some embodiments, the radius of the arc corner transition portions is greater than or equal to 30 cm.

In some embodiments, the distance between the plurality of second convex strips is 1-3 cm, which has the beneficial effects that such distance makes the whole side face plate more beautiful while the stress capacity of the side face plate is improved, and demolding after drawing is also relatively convenient.

In some embodiments, the rectangular metal shell may be made of copper, copper alloy, aluminum or aluminum alloy. The rectangular metal shell made of any of the above materials is light in weight and relatively lasting in shape keeping.

Compared with the prior art, the metal box shell obtained by the methods disclosed herein is manufactured in the manner of slow drawing at a low pressure and through two times of drawing. The arc corners are orderly and the stress capacity of the arc corners is improved. The convex grain can be formed on the shell, especially at the arc corners, so that the shell is attractive and durable. Especially, demolding is facilitated in the manufacturing process, and the production process is simplified.

### BRIEF DESCRIPTION OF THE DRAWINGS

FIG. 1 is a schematic view of a three-dimensional structure of a metal box prepared by a method of manufacturing an arc corner connecting rib of a metal box shell according to an embodiment of the present disclosure;

FIG. 2 is a schematic structural view of the metal box shown in FIG. 1 in another direction;

FIG. 3 is a schematic structural view of a first drawing in a method of manufacturing an arc corner connecting rib of the metal box shell according to an embodiment of the present disclosure; and

FIG. 4 is a schematic structural view of a second drawing in a method of manufacturing the an arc corner connecting rib of the metal box shell according to an embodiment of the present disclosure.

### DETAILED DESCRIPTION

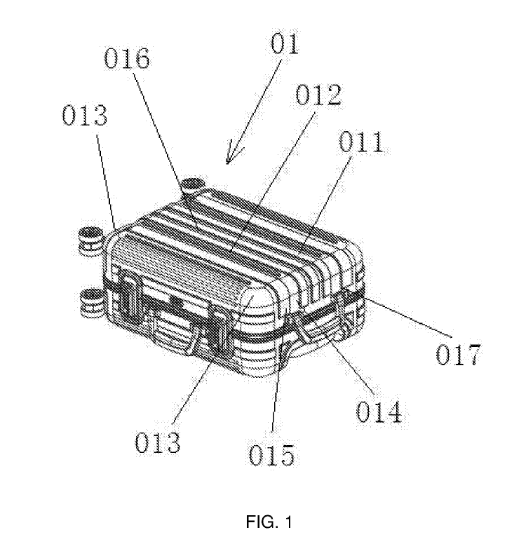

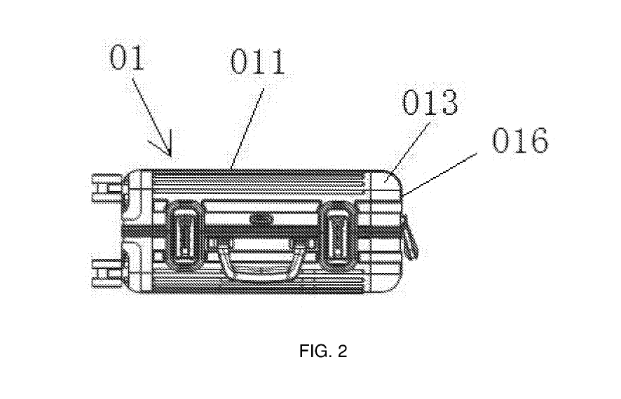

The present disclosure will now be further described with reference to FIGS. 1-4.

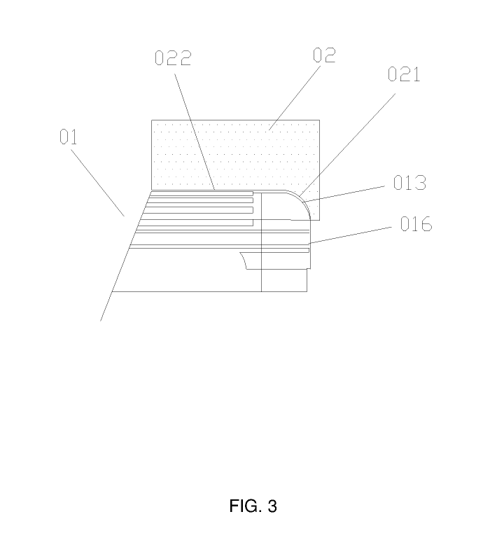

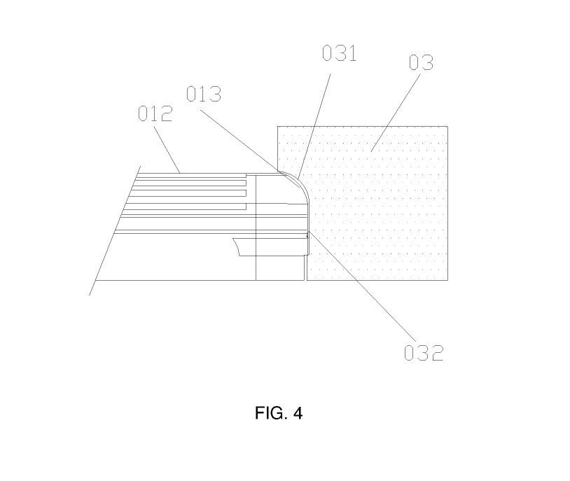

Presently disclosed is a method of drawing an arc corner connecting rib or a metal box shell. Referring to FIGS. 1-4, a method of manufacturing an arc corner connecting rib of a metal box shell is disclosed. The method comprises preparing a rectangular metal shell 01 whose vertex corner portions are arc corner transition portions 013, and drawing, for a first time by means of a first metal drawing mold 02, a top face plate 011 of the rectangular metal shell 01. The rectangular metal shell 01 is a copper shell, a copper alloy shell, an aluminum shell or an aluminum alloy shell. Referring to FIG. 3, the first metal drawing mold 02 comprises a first arcuate groove 021 and a top face groove 022 connected to the first arcuate groove 021. The top face plate 011 of the rectangular metal shell 01 is placed at the top face groove 022, a part of a side face plate 017 is placed at the first arcuate groove 021, and a plurality of first grooves are formed in the top face groove 022. The top face plate 011 of the rectangular metal shell 01 is drawn under the action of pressure, so that a plurality of first convex strips 012 corresponding to the first grooves are formed in a first area 016 between the two arc corner transition portions 013 of the top face plate 011. The first drawing is completed by using a hydraulic machine to pressurize the first metal drawing mold. The method of manufacturing further comprises drawing, for a second time, by means of a second metal drawing mold 03, a side face plate 017 and the arc corner transition portions 013 of the rectangular metal shell obtained after the first drawing molding. Referring to FIG. 4, the second metal drawing mold 03 comprises a second arcuate groove 031 and a side face groove 032 connected to the second arcuate groove 031. The side face plate 017 of the rectangular metal shell 01 is placed at the side face groove 032, the whole arc corner transition portions 013 are placed at the second arcuate groove 031, and the side face groove 032 and the second arcuate groove 031 are respectively provided with a second groove. The side face plate 017 of the rectangular metal shell 01 is drawn under the action of pressure, so that a plurality of second convex strips 015 corresponding to the second groove are formed in a second area 014 between the two arc corner transition portions 013 of the side face plate 17. The second drawing is completed by using the hydraulic machine to pressurize the second metal drawing mold 03. Through the first drawing, the plurality of first convex strips 012 can be formed in the first area 016; and through the second drawing, the plurality of second convex strips 015 can be formed in the second area 014 between the arc corner transition portions 013. As there is a groove between the two second convex strips 015, it may be hard to demold through the first drawing molding, and also the second drawing forming is performed. Therefore through two times of drawing, the arc corners can be orderly, and the stress capacity of the arc corners is improved; meanwhile, convex grain can be formed on the shell, especially at the arc corners, so that the shell is attractive and durable. Demolding is facilitated in the whole manufacturing process, the production process is simplified, and the occurrence rate of defective products is reduced.

The distance between the plurality of second convex strips 015 is 1-3 cm, which has the beneficial effects that such distance makes the whole side face plate more aesthetically appealing while the stress capacity of the side face plate is improved, and demolding after drawing is also relatively convenient.

Compared with the prior art, the metal box shell obtained by the method provided herein is manufactured in the manner of slow drawing at a low pressure and through two times of drawing. The arc corners are orderly and the stress capacity of the arc corners is improved. Meanwhile, the convex grain may be formed on the shell, especially at the arc corners, so that the shell is attractive and durable. Demolding is facilitated in the manufacturing process, and the production process is simplified.

The above embodiments are only part of embodiments of the present invention. It should be noted that other modifications and improvements, which may be made by those skilled in the art without departing from the inventive concept of the present invention, shall be embraced by the protective scope of the present invention.

While various embodiments have been described, it is to be understood that variations and modifications may be resorted to as will be apparent to those skilled in the art. Such variations and modifications are to be considered within the purview and scope of the claims appended hereto.

It is to be understood that, as used herein, the terms “the,” “a,” “an,” mean “at least one,” and should not be limited to “only one” unless explicitly indicated to the contrary. Unless otherwise indicated, all numbers used in the specification and claims are to be understood as being modified in all instances by the term “about,” whether or not so stated. It should also be understood that the precise numerical values used in the specification and claims form additional embodiments of the invention, and are intended to include any ranges, which can be narrowed to any two end points within the example ranges and values disclosed herein. Any measured numerical value, however, can inherently contain certain errors resulting from the standard deviation found in its respective measuring technique.

1. A method of manufacturing an arc corner connecting rib of a metal box shell, the method comprising the following steps:
preparing a rectangular metal shell whose vertex corner portions are arc corner transition portions;
drawing for a first time by means of a first metal drawing mold a top face plate of the rectangular metal shell, so that a plurality of first convex strips are formed in a first area between the arc corner transition portions of the top face plate; and
drawing for a second time by means of a second metal drawing mold a side face plate and the arc corner transition portions of the rectangular metal shell obtained after the first-time drawing molding a second time, so that a plurality of second convex strips are formed in a second area between the arc corner transition portions of the side face plate.

2. The method of manufacturing of claim 1, wherein the radius of the arc corner transition portions is greater than or equal to 30 cm.

3. The method of manufacturing of claim 1, wherein the distance between the plurality of second convex strips is 1-3 cm.

4. The method of manufacturing of claim 1, wherein the rectangular metal shell is a copper shell, a copper alloy shell, an aluminum shell or an aluminum alloy shell.
